(19) United States
(12) Patent Application Publication
(10) Pub. No.: US 2012/0103942 A1
(43) Pub. Date: May 3, 2012

(54) METHOD FOR MANUFACTURING A TUBULAR FRAME STRUCTURE WITH STAND ALONE NODE

(75) Inventors: Andrzej M. Pawlak, Rochester Hills, MI (US); Timothy C. Hays, Troy, MI (US); Alain Piete, Oxford, MI (US)

(73) Assignee: DELPHI TECHNOLOGIES, INC., TROY, MI (US)

(21) Appl. No.: 13/125,124

(22) PCT Filed: Oct. 22, 2009
(86) PCT No.: PCT/US2009/061642

§ 371 Date: Nov. 8, 2011

Related U.S. Application Data
(60) Provisional application No. 61/196,933, filed on Oct. 22, 2008.

(51) Int. Cl. B23K 11/00; F16L 21/00

(52) U.S. Cl. 219/67; 403/217

(57) ABSTRACT

A method of making a structural connection in a metallic tubular assembly is provided. It comprises providing a node having at least two legs and forming a radially extending rib extending from an exterior surface of each of the legs by deforming a corresponding interior portion of each of the legs. At least one tube is provided having a radially extending flange adjacent an open end. The tube is placed over the exterior surface of one of the legs abuts the radially extending flange and the radially extending rib. By applying opposing forces to one of the legs and one tube to hold the radially extending flange and the radially extending rib in abutting contact at a joint, resistance welding can take place at the joint when at least one electrode is applied to the joint.

### CROSS REFERENCE TO RELATED APPLICATIONS

This application claims the benefit of U.S. Provisional Application Ser. No. 61/196,933 filed Oct. 22, 2008, the contents of which are incorporated by reference herein.

### TECHNICAL FIELD

The subject matter disclosed herein relates to a method for preparing tubular structure frames and tubular support structures for deformation resistance welding.

### BACKGROUND OF THE INVENTION

Resistance welding of a first metal member to a second metal member (also known as electric-resistance welding) is a known metallurgical process in which the first and second metal members are heated by their own electrical resistance to a semi-fused or a fused state by the passage of very heavy electrical currents through the members for very short lengths of time. By forcing the first and second members together under pressure while the welding current is applied across the members, the members are then welded together. Resistance welding has many advantages in efficiently and effectively providing consistently reliable welds in high-volume manufacturing operations, when compared to alternative brazing or welding methods using gas torches or electrical arcs.

In order to achieve a complete resistance weld of the interface between the two mating members, the members must fit together very tightly at the interface at the time welding current is applied. It has been difficult to economically resistance weld together thin-walled metal members together, due to the need for having the members fit together tightly. Metal members where this was difficult include metals in the form of sheets, tubes, or similar shapes. In high-volume production, even where the configuration of the members is fairly simple, such members have been typically brazed or arc welded together rather than being resistance welded.

For example, in order to resistance weld a metal sheet or tube to another tube, the mating edges or surfaces of the members to be joined had to be cut or prepared along a three-dimensional contour so that the intersection between the members would fit together tightly enough before welding—to allow a good weld joint to be made. This can be difficult to achieve in thin-walled members that tend to flex under the pressure of the tooling used for preparing the mating edges or surfaces. The manufacturing costs for preparing the edges of the members to achieve an acceptably tight fit before welding, together with the cost of engineering for designing the members themselves and the equipment used for machining the members to achieve a tightly filling interface has been expensive. In addition to the cost associated with machining the members, complex fixtures were required to hold the members in position and to apply pressure along an interface, which is often three-dimensional, during resistance welding of the interface.

U.S. Pat. No. 6,552,294, to Ananthanarayanan, et al, and U.S. Pat. No. 6,693,251 to Ananthanarayanan, et al, each of which is hereby incorporated by reference herein, provide methods for attaching tubular assemblies using resistance welding. These and other methods require forming processes, sometimes complicated, to prepare the parts for welding. For instance, forming kinks in thin walled tubing can result in uneven stresses in the tubing, or uneven kinks that do not line up well with a mating flange in the successive welding step. As such, some parts are subject to being scrapped. Further improvement of the resistance welding of annular shapes would be accomplished with a more uniform formation of the joint in preparation for welding parts together.

### SUMMARY OF INVENTION

A method of making a stand-alone node structure to connect tubular structure frames and tubular support structures that are welded together using the deformation resistance welding (DRW) process is provided. A collapsible element of the node allows for relative motion between the node and tubes parts during welding.

According to one aspect of the invention, a method of making a structural connection in a metallic tubular assembly is provided. It comprises providing a node having at least two legs and forming a radially extending rib extending from an exterior surface of each of the legs by deforming a corresponding interior portion of each of the legs. At least one tube is provided having a radially extending flange adjacent an open end. The tube is placed over the exterior surface of one of the legs abuts the radially extending flange and the radially extending rib. By applying opposing forces to one of the legs and one tube to hold the radially extending flange and the radially extending rib in abutting contact at a joint, resistance welding can take place at the joint when at least one electrode is applied to the joint.

According to another aspect of the invention, a node for joining metallic tubes together in a structural assembly is provided. It comprises a first portion comprising three partial cylinder portions bounded by axially extending flanges. The three cylinders have a common intersection point and each of the three partial cylinders having at least one radially extending rib. A second portion comprises three partial cylinder portions bounded by axially extending flanges. The three cylinders also have a common intersection point and each of the three partial cylinders has at least one radially extending rib. The first portion is connected to the second portion at abutting radially extending flanges.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an exemplary embodiment of the invention;

FIG. 2 is a cross-sectional detail view, taken along the line 2-2 of FIG. 1;

FIG. 3 is a detail view, partially in cross-section, taken along line 3-3 of FIG. 1;

FIG. 4 is an exploded view of a joint in accordance with an exemplary embodiment of the invention;

FIG. 5 is an isometric view of an exemplary embodiment of the invention;

FIG. 6. is a side view of one aspect of the exemplary embodiment of FIG. 5;

FIG. 7 is a detail view taken along line 7-7 of FIG. 6;

FIG. 8 is an exploded view of the exemplary embodiment shown in FIG. 5;

FIG. 9 is an illustration of joints formed in accordance with an exemplary embodiment of the invention;

FIG. 10 is a detail view of joints formed in accordance with an exemplary embodiment of the invention; and

FIG. 11 is an illustration of the steps to carry out an exemplary embodiment of the invention.

### DETAILED DESCRIPTION OF THE INVENTION

Referring now to the Figures, where the invention will be described with reference to specific embodiments, without limiting same, the invention provides a node to connect tubular structural frames and tubular support structures that are manufactured using a Deformation Resistance Welding process (DRW).

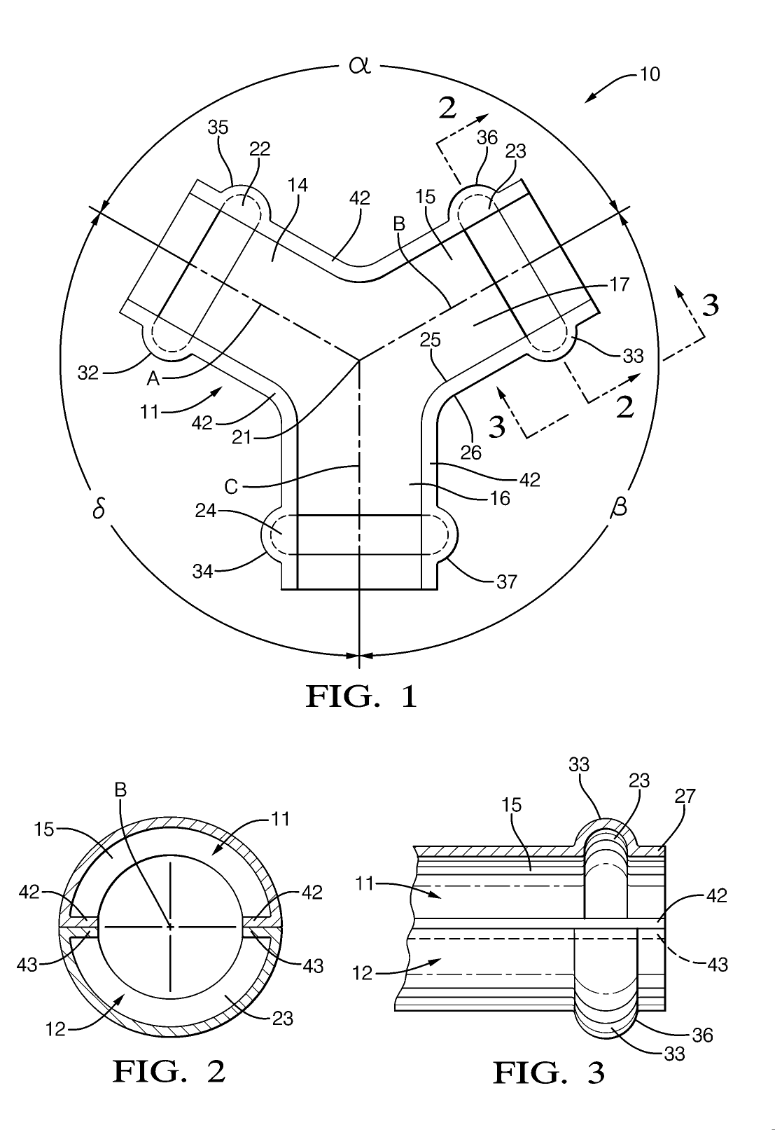

An exemplary embodiment of a node 10, useful as connection point or redistribution point for a structural frame (not shown) is shown in FIGS. 1-4. Node 10 is comprised of two generally equal halves, a first upper clamshell portion 11 and a second lower clamshell portion 12 forming an interior portion 17 of node 10. As shown, node 10 is comprised of three equidistant node legs—first leg 14, second leg 15 and third leg 16. Each leg 14, 15 and 16 is generally cylindrical in shape and defined by an axis A, B and C, respectively and has an exterior diameter. As shown the arc angle, α, β, and γ, between adjacent axes A, B, C is 120 degrees. It will be appreciated that other alternative embodiments of node 10 may include elliptical or oval shaped tubing, when viewed in cross-section, or the arc angles, α, β, and γ, may be of varying angles such that only two are the same or that none of the angles are the same. Each of the varying embodiments fall within the scope of the invention, and the exemplary embodiment shown is not meant to limit the invention.

The axes A, B and C each fall within a common plane, though it is contemplated that other embodiments may include one or more of axes A, B and C falling in different planes, though corresponding legs 14, 15 or 16 will still intersect at node intersection point 21. Each of legs 14, 15 and 16 contain a circumferential recess 22, 23 and 24, respectively within the inside surface wall 25 of node 10 and adjacent an outer uniform edge 27. Node 10 also includes an outer surface wall 26 and the outer uniform edge 27 extending therebetween. Outer edge 27 has a generally uniform thickness extending between the inner and outer surface walls 25, 26. Circumferential recesses 22, 23 and 24 form corresponding radially extending circumferential ribs 32, 33 and 34 on outer surface wall 26. Each rib 32, 33 and 34 has a leading edge 35, 36 and 37, respectively for purposes that will be described hereinafter. In one non-limiting embodiment, node 10 is comprised of a low carbon steel such as AISI 1008 to 1010 having a generally uniform edge 27 with a thickness of generally 2 millimeters.

As discussed above, first upper portion 11 and second lower portion 12 are generally uniform in size and shape so that they may mate together in a clamshell type configuration to form node 10. Each of first and second portions 11, 12 starts out as a flat piece of sheet metal. The portions 11 and 12 are generally identical in size and shape, and after stamping are a mirror image of each other. In one exemplary embodiment, first upper portion 11 is stamped to create a semi-cylindrical clamshell portion 11 with at least one partial cylinder bounded by axially extending flanges 42 on the outer edges. Each one half cylinder, when joined with second lower portion 12, as described below, becomes one half of legs 14, 15 and 16. One-half of the recesses 22, 23 and 24 are stamped on the inside surface wall 25 to create one-half of the radially extending ribs 32, 33 and 34, while second lower portion 12 is stamped to create a semi-cylindrical clamshell portion 12 with at least one partial cylinder bounded by axially extending flanges 43 on the outer edges. Each one half cylinder, when joined with first upper portion 11, becomes one half of legs 14, 15 and 16. One-half of the recesses 22, 23 and 24 are stamped on the inside surface wall 25 of second lower portion 12 to create one-half of the radially extending ribs 32, 33 and 34. When first upper portion 11 and second lower portion 12 are joined together at flanges 42 and 43, node 10 is formed.

It will be appreciated that flanges 42, 43 may be formed together with resistance welding, arc welding or the like to form single node receptacle 10. By stamping recesses 22, 23 and 24 at the same time as node 10 is being stamped in first and second clamshell portions 11 and 12, elimination of an additional forming step to create a kink in each of legs 14, 15 and 16 is eliminated.

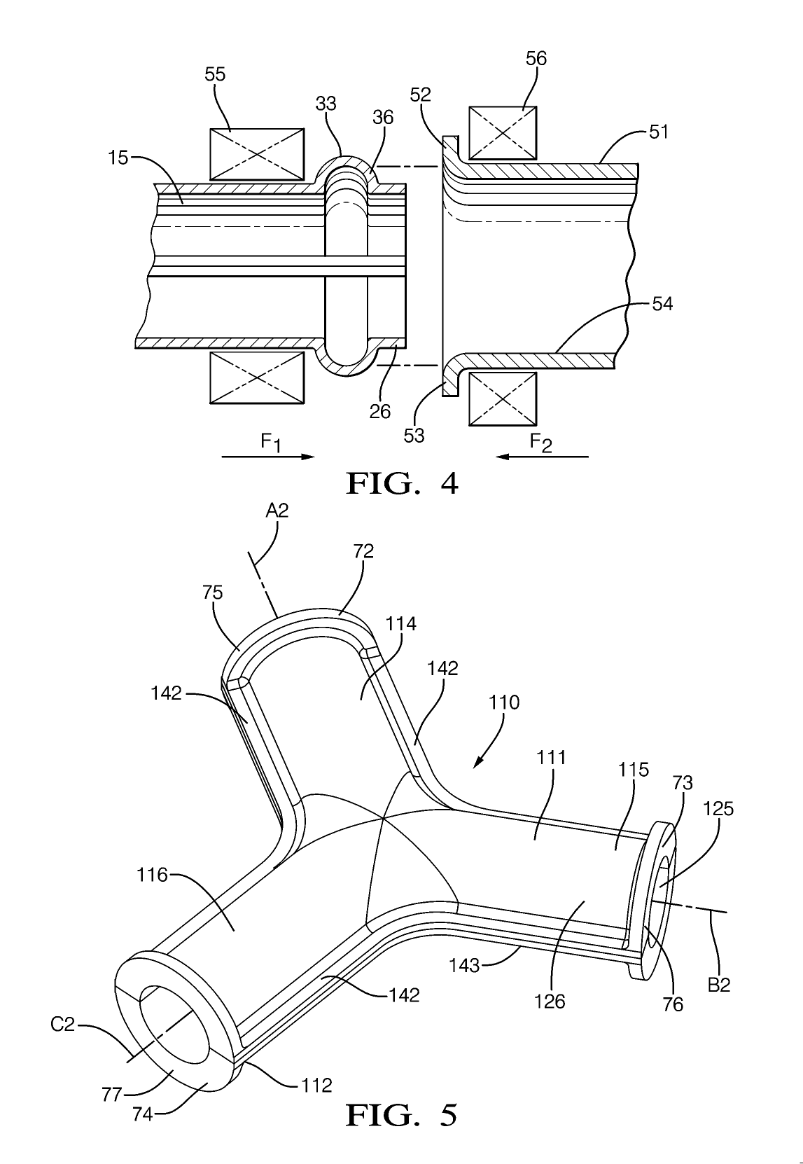

With reference now to FIGS. 4 and 10, and as best shown in the exploded view of FIG. 4, an example of the deformation resistance welding process as applied to node 10 is shown. A force F1 is applied to leg 15 of node 10 and a corresponding opposite force F2 is applied to thin walled tube 51. Thin walled tube 51 has been formed with a radially extending circumferential flange 52 at a face edge 53. Forces F1 and F2 cause rib 33 to circumferentially abut against flange 52 and outer surface wall 26 to slide within an inner surface wall 54 of thin walled tube 51. Electrodes 55 and 56, which may be circumferential or partially circumferential, abut each of ribs 33 and flange 52, respectively, to cause deformation resistance welding and join leg 15 of node 10 to thin walled tube 51 circumferentially along the face edge 53 of flange 52 and the leading edge 36 of rib 33. It will be appreciated that flange 51 is also useful to accommodate and support electrode 56 and the application of Forces F1 and F2 during the welding process.

The resulting formed joint 60 is shown in FIG. 10. There it can be seen that recesses 22, 23 and 24 were useful to provide a collapsible element that allowed for relative motion between node 10 and tube 51 during welding to form joint 60. While rib 33 remains it will be appreciated that the combination of resistance heating an plastic deformation causes recess 23 to generally collapse onto itself in the interior portion 17 of recess 23. The resistance heating is due to the application of the welding current and the plastic deformation is due to the opposite Forces F1 and F2. Legs 14 and 16 are welded in a like manner to tubes (not shown).

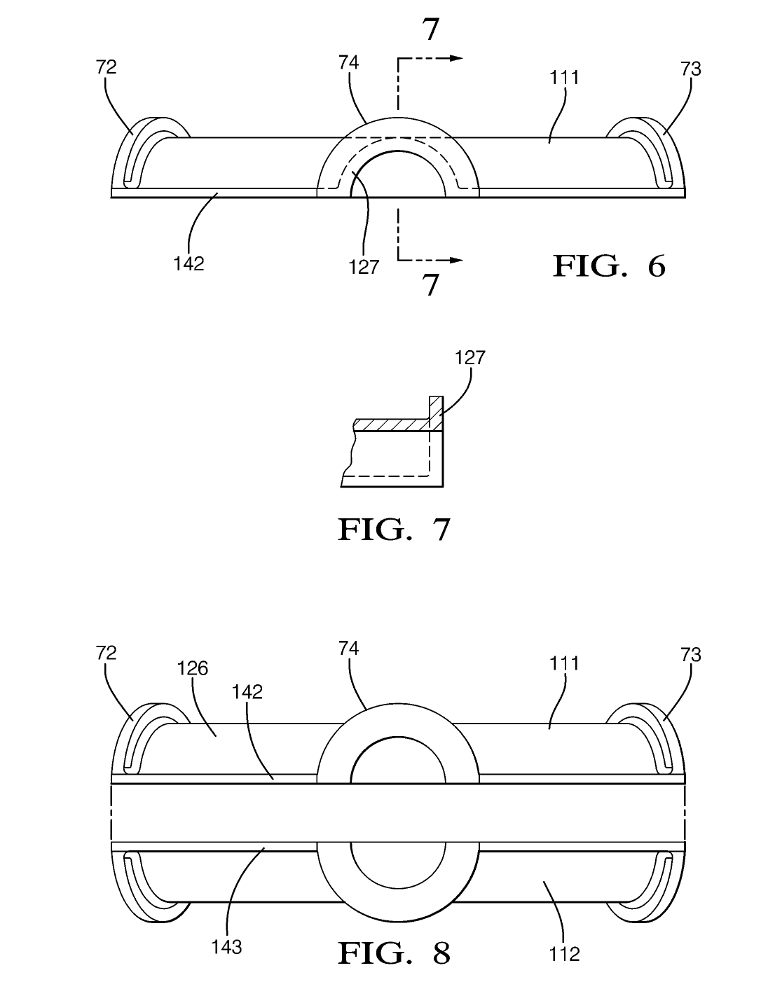

In another exemplary embodiment, where like numerals will be used to show like elements, node 110 is illustrated in FIGS. 5-9. Node 110 is comprised of two generally equal halves, a first upper clamshell portion 111 and a second lower clamshell portion 112 forming an interior portion 117 of node 110. As shown, node 110 is comprised of three equidistant node legs—first leg 114, second leg 115 and third leg 116. Each leg 114, 115 and 116 is generally cylindrical in shape and defined by an axis A2, B2 and C2, respectively. As shown the arc angle, between adjacent axes A2 B2, C2 is 120 degrees. It will be appreciated that other alternative embodiments of node 110 may include elliptical or oval shaped tubing, when viewed in cross-section, or the arc angles, may be of varying angles such that only two are the same or that none of the angles are the same. Each of the varying embodiments fall within the scope of the invention, and the exemplary embodiment shown is not meant to limit the invention.

The axes A2, B2 and C2 each fall within a common plane, though it is contemplated that other embodiments may include one or more of axes A2, B2 and C2 falling in different planes, though corresponding legs 114, 115 or 116 will still intersect at a common node intersection point (not shown). Each of legs 114, 115 and 116 contain a circumferential mating flange 72, 73 and 74, respectively at a mating face edge 75, 76 and 77 of node 110. Like node 10, node 110 also includes an inside surface wall 25, an outer surface wall 126 and a uniform edge 127 extending therebetween, and having a generally uniform thickness extending between the inner and outer surface walls 125, 126. In one non-limiting embodiment, node 10 is comprised of a low carbon steel such as AISI 1008 to 1010 having a generally uniform edge 27 with a thickness of generally 2 millimeters.

Like the embodiment above, first upper portion 111 and second lower portion 112 are generally uniform in size and shape so that they may mate together in a clamshell type configuration to form node 10. Each of first and second portions 111, 112 starts out as a flat piece of sheet metal. The portions 111 and 112 are generally identical in size and shape. In one exemplary embodiment, first upper portion 111 is stamped to create a semi-cylindrical clamshell portion 111 having flanges 142 on the outer edges. One-half of the mating flanges 72, 73 and 74 are formed by a stamping process, while second lower portion 112 is stamped to create a semi-cylindrical clamshell portion 112 having flanges 143 on the outer edges. One-half of the mating flanges 72, 73 and 74 are formed by a stamping process. When first upper portion 111 and second lower portion 112 are mated together at flanges 142 and 143, node 110 is formed.

It will be appreciated that flanges 142, 143 may be formed together with resistance welding, arc welding or the like to form single node receptacle 110. By stamping mating flanges 72, 73 and 74 at the same time as node 110 is being stamped in first and second clamshell portions 111 and 112, elimination of an additional forming step to create a flanges in each of legs 114, 115 and 116 is eliminated.

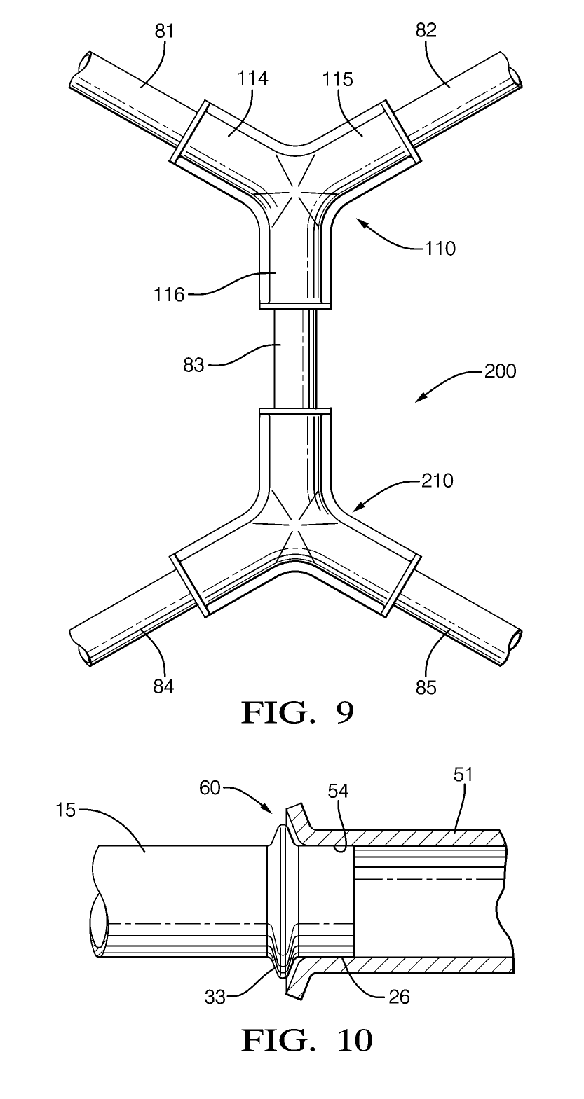

It will be appreciated that node 110, and specifically legs 114, 115 and 116 can be joined to tubes 81, 82 and 83, respectively, as shown in FIG. 9, in a mirror image fashion to that shown in FIGS. 4 and 10. In other words, each of tubes 81, 82 and 83 will have a recess in the interior and a corresponding rib on the exterior surface of the tube for circumferential mating with the mating face edges 75, 76 and 77 of node 110 to form welded joints 160. As shown in FIG. 9, a node 210 can be included to form a metallic tubular assembly 200 which allows four tubes to be joined at structural junction 200. This is accomplished by the use of tube 83 which is a short length of tube having ribs on each end and additional tubes 84 and 85.

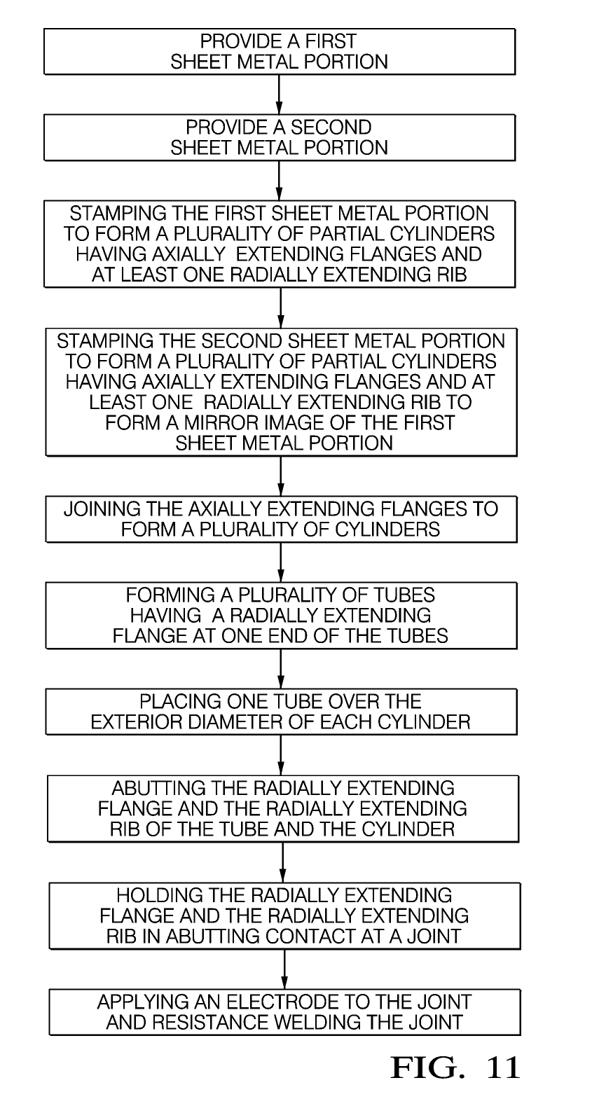

It will be appreciated that the details of the embodiments of FIGS. 1-4 and 10 and FIGS. 5-9 are interchangeable. For instance, two of nodes 10 can be substituted for nodes 110 and 210 and tubes 51 substituted for tubes 81-85, shown in FIG. 9. Referring now to FIG. 11, an exemplary embodiment of the method 300 of constructing node 10 is illustrated.

Tubular nodes 10 and 110 replace more conventional cast or stamped stand-alone tubular nodes that may not have such a recess or flange around a periphery. Forming the recess or flange by a stamping process at the same time as forming a node eliminates additional forming process to create a kink or flange in at node in preparation for the deformation resistance welding process. In addition, the geometry of the recess stamping or flange forming should be done in such a way to allow for an electrode to be applied for the welding process. The geometry of the recess deformation should also be done in such a way to allow for any tube material thickness and any tubular geometry of a node, or vice versa, to fit within the tube. It will also be appreciated that each of legs of node 10 or 110 need not be welded to a tube. Nodes 10 and 110 are intended to be generic connections in a large structural array. As such nodes 10 and 110 serve to connect tubes as dictated by the requirements of the structural array.

In one exemplary embodiment, pulses (totaling ⅓ of a second) of electric current of generally 5,000 amperes (and in one variation 15,000 to 20,000 amperes) are applied while applying a force of generally 300 to 800 pounds to the electrodes which abut against ribs and flanges to form Forces F1 and F2 to bring node 10 together with tubes 51 and the like, or node 110 together with tubes 81, 82 and 83. The joining of materials by the deformation resistance welding is not limited to specific materials, dimensions, electric current, and forces, as is understood by those skilled in the art. Any materials capable of being welded, such as copper, aluminum alloy, stainless steel, etc. can be used, as can be appreciated by the artisan. The particular choice of electric current, forces, and part dimensions, etc. are within the ordinary level of skill of the artisan.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method of making a structural connection in a metallic tubular assembly comprising;
providing a node having at least two legs;
forming a radially extending rib extending from an exterior surface of each of said legs by deforming a corresponding interior portion of each of said legs;
providing at least one tube have a radially extending flange adjacent an open end;
placing said at least one tube over said exterior surface of one of said at least two legs and abutting said radially extending flange and said radially extending rib;
applying opposing forces to said one of said at least two legs and said tube to hold said radially extending flange and said radially extending rib in abutting contact at a joint;
applying at least one electrode to said joint; and
resistance welding said joint.

2. The method of claim 1, including providing at least two tubes having radially extending flanges and resistance welding said at least two tubes to said at least two legs.

3. The method of claim 1, wherein said node includes at least three legs.

4. The method of claim 3, including providing at least three tubes having radially extending flanges and resistance welding said at least three tubes to said at least three legs.

5. The method of claim 1, wherein said radially extending ribs together with said deformed corresponding interior portion of said at least one leg forms a collapsible element and collapsing said element during said resistance welding step.

6. The method of claim 1, including forming said node as two separate portions and joining said two separate portions to form said at least two legs.

7. The method of claim 6, including deforming a corresponding interior portion of said each of said legs prior to joining said two separate portions.

8. The method of claim 7, wherein said node includes at least three legs, each having an axis, each said falling in a common plane.

9. The method of claim 1, including two nodes connected by at least one tube.

10. A method of making a structural connection in a metallic tubular assembly comprising:
providing a first sheet metal portion;
providing a second sheet metal portion;
stamping said first sheet metal portion to form at least one partial cylinder having axially extending flanges and at least one radially extending rib;
stamping said second sheet metal portion to form at least one partial cylinder having axially extending flanges and at least one radially extending rib, said second sheet metal portion generally mirroring said first sheet metal portion;
joining said axially extending flanges to form at least one cylinder having a recess portion opposite said radially extending rib;
forming a tube having a radially extending flange at one end and having an inside diameter about equal to or larger than an exterior diameter of said cylinder;
placing said tube over said exterior diameter of said cylinder and abutting said radially extending flange and said radially extending rib;
applying opposing forces to said cylinder and said tube to hold said radially extending flange and said radially extending rib in abutting contact at a joint;
applying at least one electrode to said joint; and
resistance welding said joint.

11. The method of claim 10, including stamping said sheet metal portions to form at least three partial cylinders having axially extending flanges and at least one radially extending rib, joining said axially extending flanges to form at least three cylinders having a recess portion opposite said radially extending rib and forming at least three tubes having said radially extending flanges and resistance welding said at least three tubes to said at least three cylinders.

12. A node for joining metallic tubes together in a structural assembly comprising;
a first portion comprising three partial cylinder portions bounded by axially extending flanges, said three cylinders having a common intersection point and each of said three partial cylinder having at least one radially extending rib;
a second portion comprising three partial cylinder portions bounded by axially extending flanges, said three cylinders having a common intersection point and each of said three partial cylinder having at least one radially extending rib, said first portion connected to said second portion at abutting radially extending flanges.
